(19) United States
(12) Patent Application Publication
(10) Pub. No.: US 2010/0023991 A1
(43) Pub. Date: Jan. 28, 2010

(54) APPARATUS AND METHOD FOR SHARING TELEVISION SIGNALS VIA INSTANT MESSAGING SERVICES

(75) Inventors: Chih-Hsiang Lin, Taipei Hsien (TW); Tzu-Lung Chuang, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ACER INCORPORATED, Taipei Hsien (TW)

(21) Appl. No.: 12/260,159

(22) Filed: Oct. 29, 2008

(30) Foreign Application Priority Data
Jul. 22, 2008 (TW) 97127792

(51) Int. Cl. H04N 7/173

(52) U.S. Cl. 725/121

(57) ABSTRACT

Provided is an apparatus for sharing television signals via an instant messaging service, which comprises an instant messaging module, a television receiver and a television sharing interface, wherein the instant messaging module is used to exchange information with outside networks via the instant messaging service. The television receiver is used to receive the television signals having video signals and audio signals, and the television sharing interface is used to connect the television receiver with the instant messaging module, wherein the television sharing interface further comprises a control module, a video capture module and an audio output module. The control module is for controlling the television receiver, the video capture module is for capturing the video signal for the instant messaging module to output under control of the control module, and the audio output module is for outputting the audio signal according to the control module.

### CROSS REFERENCE TO RELATED APPLICATIONS

This Non-provisional application claims priority under 35 U.S.C. § 119(a) on Patent Application No(s). 97,127,792, filed in Taiwan, Republic of China on Jul. 22, 2008, the entire contents of which are hereby incorporated by reference.

### BACKGROUND OF THE INVENTION

1. Field of the Invention

The present invention relates to an apparatus and method for sharing television signals, and in particular relates to an apparatus and method for sharing television signals via an instant messaging service.

2. Description of the Related Art

Instant messaging services are very popular network applications, and almost every internet user has access to instant messaging services, like MSN Messenger, Skype, or Yahoo Messenger. By installing and logging on to network application software, users from two or more nodes in the network are able to communicate with each other. Generally, the communication means via the instant messaging services are through text messaging. However, visual and audio means may be used along with transmit of data or files. FIG. 1 is an illustrative diagram of an instant messaging service. Two nodes 100 and 130 on the internet respectively login to the instant messaging service to connect with each other. When taking the chat window 140 shown on the side of the node 130 as an example, the messages transmitted between the two nodes 100 and 130 are presented in the dialogue column 142. If the node 100 is equipped with a webcam 102 and microphone 104, dynamic images and voice of the node 100 can be transmitted to the node 130, and respectively be presented on the image column 144 and outputted from the speaker 13.

Meanwhile, as network applications continue to grow in popularity many internet users are now enjoying television programs via networks. Internet Protocol Television (IPTV) is one popular network application, wherein a television system transmits television signals using a broadband network as its medium. IPTV providers transmit television programs over digital television signals to users with internet protocol, and users receive the digital television signals with their digital television cards to view the television programs offered.

Thus, given the above two trends, a combined network television system with instant messaging capabilities is desired, wherein the combined system will allow users to share television programs via instant messaging service in real time.

### BRIEF SUMMARY OF INVENTION

The present invention provides an apparatus for sharing television signals via an instant messaging service, comprising an instant messaging module, a television receiver, and a television sharing interface. The instant messaging module is used to exchange information with outside networks via the instant messaging service. The television receiver is used to receive the television signals having video signals and audio signals and the television sharing interface is used to connect the television receiver with the instant messaging module. The television sharing interface further comprises a control module, a video capture module and an audio output module. The control module is for controlling the television receiver, the video capture module is for capturing the video signals for the instant messaging module to output under control of the control module, and the audio output module is for outputting the audio signals under control of the control module.

The present invention also provides a method for sharing television signals via the instant messaging service, comprising: providing an instant messaging module used to exchange information with outside networks via the instant messaging service; and providing a television receiver to receive the television signals having video signals and audio signals. Additionally, the television receiver is connected with the instant messaging module, and the method further comprises: controlling the television receiver; capturing the video signals received by the television receiver for the instant messaging module for output; and outputting the audio signals.

The present invention also provides a machine readable medium, storing a computer program for performing a method for sharing television signals via the instant messaging service, wherein the method comprises: connecting a television receiver of the machine with an instant messaging module of the machine; controlling the television receiver; capturing a video signal of the television signals received by the television receiver for the instant messaging module to output; and outputting an audio signal of the television signals received by the television receiver.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is an illustrative diagram of the instant messaging service;

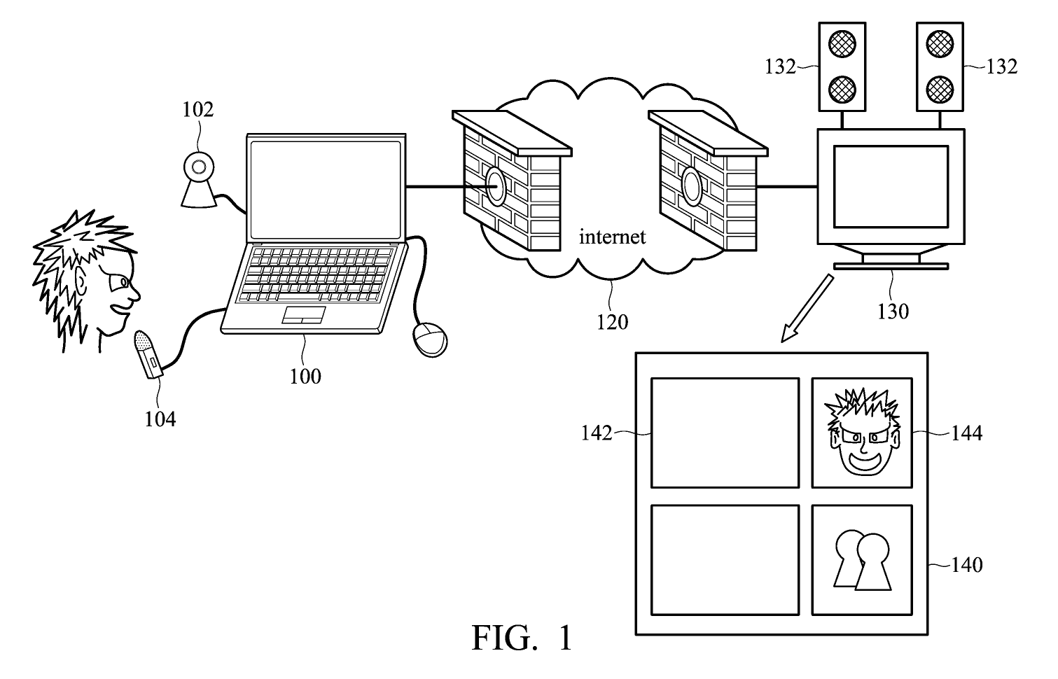

FIG. 2 is a schematic diagram illustrating the apparatus for sharing television signals via the instant messaging service according to an embodiment of the present invention;

FIG. 3A is a flow chart illustrating the method for sharing television signals via the instant messaging service according to an embodiment of the present invention;

FIG. 3B is a flow chart illustrating the step S306 of the FIG. 3A; and

FIG. 4 is flow chart illustrating a method performed by a computer program stored in a machine readable medium for sharing television signals via the instant messaging service.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

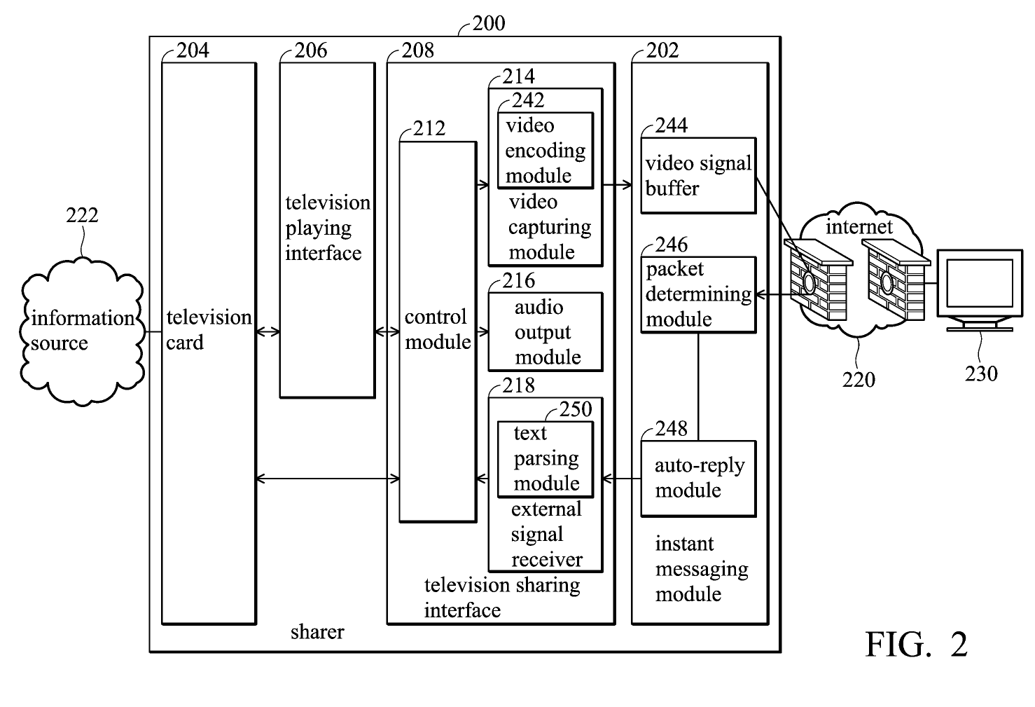

FIG. 2 is a schematic diagram illustrating the apparatus for sharing television signals via the instant messaging service according to an embodiment of the present invention. A sharer 200 and a receiver 230 are both nodes of an internet 220. An apparatus of the present invention is disposed on the sharer 200, which shares television signals with the receiver 230 via the instant messaging service. The sharer instant messaging module 202 comprises an instant messaging module 202, a television card 204, a television playing interface 206 and a television sharing interface 208.

The instant messaging module 202 having the instant messaging service, which is discussed above in the prior art, can transmit information to any node through the internet, which also has the same instant messaging service. Note that the apparatus of the present invention can share the television signal with more than one node simultaneously, although only the receiver 230 is taken for example hereinafter, and is not limited thereto. Generally, information transmitted via instant messaging services are text messages, however, information transmitted in the present invention can comprise visual and audio data. The television card 204 of the present invention receives various television programs transmitted in the form of television signals from the information source 222, wherein the television signals can be further separated into video signals and audio signals. The signals received by the television card 204 in the present invention is not limited to be in digital form as discussed in the description of the related art, and can also be in analog form. The television playing interface 204 is an application program under the operating system of the sharer 200, and a software interface between the sharer 200 and the television card 204, and is used to play the television programs received by the television card 204.

In brief, the principle of the present invention for sharing television signals via the instant messaging service is to make the television card 204 a simulation of the webcam 102, as discussed in the description of the related art. Therefore, the images received by the television card 204 are regarded as ones received by the webcam 102 and can be shared to the receiver 230 via the instant messaging service. Take the MSN Messenger system for example, with the present invention, once the sharer 200 activates the simulative webcam 102 with the receiver 230, the sharer 200 can display the television program to the receiver 230 on their chat window, and there is no other device which is required to be additionally disposed on the receiver 230. While the MSN Messenger does inform the receiver 230 that the sharer 200 has activated the webcam 102, in actuality, the video received by the receiver 230, due to the embodiments of the present invention, is not actually from the webcam 102 of the sharer 200 but from the television card 204 of the sharer 200 instead.

To achieve the purpose described above, the present invention provides a television sharing interface 208, which is used to connect the television card 204 with the instant messaging module 202. The television sharing interface 208 can be an application program, for example, it can be written by the Windows DirectShow Architecture under the Windows operating system. The television sharing interface 208 further comprises a control module 212, a video capturing module 214, and an audio output module 216. The control module 212 is connected to the television card 204 and is able to control the television card 204. Moreover, the control module 212 can also control the television card 204 via the television playing interface 204. In one embodiment, the control module 212 activates the television card 204, searches the controls, such as “play”, “pause” and “channel-switching”, and then further controls the television card 204. The video capturing module 214 directly outputs the video signals from the television card 204 in a form supported by the television card 204 to the instant messaging module 202. Alternatively, the video capturing module 214 captures the video signals playing in the television playing interface 204, transforms the video signals into a simulation of images received by the webcam 102, and then outputs the video signals to the instant messaging module 202. Finally, the instant messaging module 202 shares the video signals with the receiver 230 via the instant messaging service. Meanwhile, the audio signals can be redirected to the microphone 104, which is discussed in the description of the related art, and be outputted by the instant messaging module 202 and then shared with the receiver 230 via the instant messaging service. Note that the audio signals can also be outputted by the operating system or other application programs. In addition, the video capturing module 214 can further comprise a video encoding module 242, which is used to encode and/or compress the video signal. The video capturing module 214 can further comprise a video signal buffer 244, which is for buffering the video signals when the instant messaging module and the outside transmit information with each other. The additional two modules are advantageous for improving quality of communication.

The present invention can be implemented in many ways, for example, in one embodiment, when the sharer 200 of a user is at home and the instant messaging module 202 and the television card 204 of the sharer 200 are respectively kept linked to the information source 222 and the internet 220, users can just log in to the instant messaging service to receive television programs provided by the sharer 200 from the receiver 230, without any location restrictions on the receiver 230. In this embodiment, it is necessary for the sharer 200 to be controlled by the receiver 230, therefore the instant messaging module 202 of the present invention further comprises a packet determining module 246 and an auto-reply module 248, wherein the packet determining module 246 is for determining whether the internet 220 has issued a control signal to the sharer 200, and the auto-reply module 248 is for determining whether to be controlled by the control signal when the packet determining module 246 has received the control signal from the outside network. For example, when the receiver 230 issues a “video conference invitation”, which can be regarded as the control signal, to the sharer 200 and receives a packet determining module 246, the auto-reply module 248 may determine whether to authorize the receiver 230 and accept the video conference invitation. Because it is desirable for the television card 204 of the sharer 200 to be further controlled by the receiver 230, the television sharing interface 208 further comprises an external signal receiver 218, which is used to receive the control signal from the receiver 230 via the instant messaging module 202 to output the control signal to the control module 212. Since the control signal issued by the receiver 230 is simply a text message, for example, “Ch +” or “Ch −” (indicating whether a channel is switched upward or downward), the external signal receiver 218 further comprises a text parsing module 250, which is used to parse the text message and transform the test message into the control signal which can be accepted by the control module 212. However, the type of the control signal is not limited to the embodiment, and those skilled in the art can dispose a plug-in control panel on the instant messaging service of the receiver 230, and directly employ the control panel to control the external signal receiver 218. Thus, completing disclosure of the apparatus of the present invention for sharing television signals via the instant messaging service.

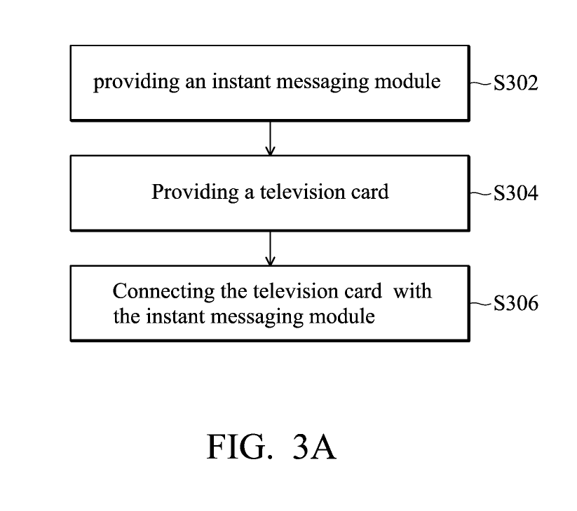

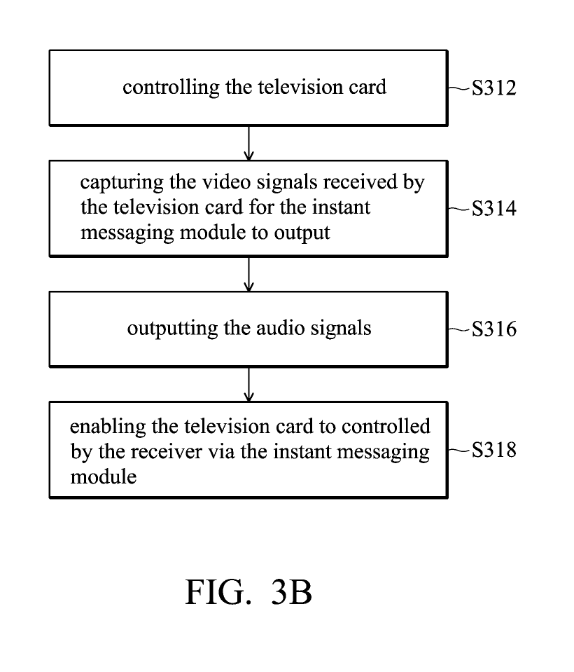

FIG. 3A is a flow chart illustrating the method for sharing television signals via the instant messaging service according to an embodiment of the present invention. Referring to FIG. 2 and FIG. 3, the method comprises providing an instant messaging module 202 for exchanging information with the receiver 230 on the internet 220 via the instant messaging service as shown in step S302. Next, a television card 204 for receiving the television signals of various television programs from the information source 222 is provided, wherein the television signals further comprise video signals and audio signals, as shown in step S304. Finally, the television card 204 is connected to the instant messaging module 202 as shown in step S306. FIG. 3B is a flow chart illustrating the step S306 of the FIG. 3A. The step S306 further comprises searching the control of the television card 204, such as “play”, “pause” and “channel-switching”, and then controlling the television card 204 as shown in step S312. Next, the video signals received by the television card 204 for the instant messaging module 202 is captured for output as shown in step S314, and the audio signals or output for display in step S316. In addition, the television card 204 is further controlled by the receiver 230 via the instant messaging module 202 as shown in step S318.

Following are more detailed steps of the method for sharing television signals via the instant messaging service discussed above. For example, in the step S314, the video signals can be encoded and/or compressed after being captured, and in the step S302, the video signal can be buffered when the television card 204 and the receiver 230 transmit information with each other. The two steps are advantageous for improving quality of communication. In addition, in the step 302, the receiver 230 determines whether to issue the control signal to the sharer 200 via the instant messaging service, and when the control signal from the receiver 230 is received via the instant messaging service, the step S302 further comprises determining whether to be controlled by the receiver 230. Similarly, the control signals in the step S318 may be a text message.

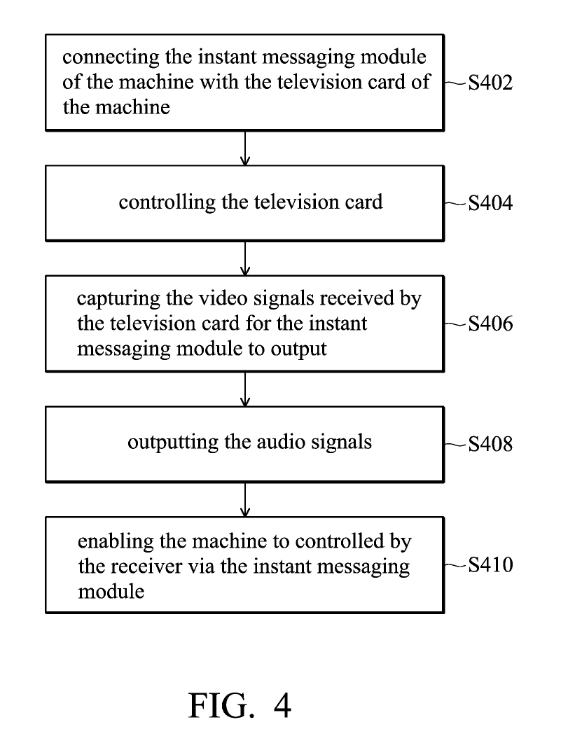

FIG. 4 is flow chart illustrating a method performed by a computer program stored in a machine readable medium for sharing television signals via the instant messaging service. If the machine comprises at least the instant messaging module 202 and the television card 204, and both are the same as the sharer 200 in FIG. 2, the method can be described as follows. To begin, the instant messaging module 202 of the machine is connected with the television card 204 of the machine as shown in S402. Next, the control of the television card 204, such as “play”, “pause” and “channel-switching” is determined, and the television card 204 is controlled as shown in step S404. Following, the video signals received by the television card 204 are captured for the instant messaging module 202 to output as shown in step S406; and the audio signals are output to be displayed in step S408. In addition, the machine is further controlled by the outside network as shown in step S410.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for sharing television signals via an instant messaging service,
comprising:
an instant messaging module, used to exchange information with outside networks via the instant messaging service;
a television receiver, used to receive the television signals having video signals and audio signals; and
a television sharing interface, used to connect the television receiver with the instant messaging module, further comprising:
a control module, for controlling the television receiver;
a video capture module, for capturing the video signals for the instant messaging module to output under control of the control module; and
an audio output module, for outputting the audio signals under control of the control module.

2. The apparatus for sharing television signals via the instant messaging service as claimed in claim 1, further comprising a television playing interface for operating the television receiver and playing the television signals.

3. The apparatus for sharing television signals via the instant messaging service as claimed in claim 2, wherein the control module operates the television receiver by controlling the television playing interface.

4. The apparatus for sharing television signals via the instant messaging service as claimed in claim 2, wherein the video capture module captures the video signals played in the television playing interface for the instant messaging module to output under control of the control module.

5. The apparatus for sharing television signals via the instant messaging service as claimed in claim 1, wherein the audio signals are outputted via the instant messaging module under control of the control module.

6. The apparatus for sharing television signals via the instant messaging service as claimed in claim 1, wherein the audio signals are outputted via an operating system under control of the control module.

7. The apparatus for sharing television signals via the instant messaging service as claimed in claim 1, wherein the television sharing interface further comprises an external signal receiver used to receive a control signal from outside networks via the instant messaging module to output the control signal to the control module.

8. The apparatus for sharing television signals via the instant messaging service as claimed in claim 1, wherein the video capture module further comprises a video encoding module for compressing the video signals.

9. The apparatus for sharing television signals via the instant messaging service as claimed in claim 1, wherein the instant messaging module further comprises a video signal buffer for buffering the video signals when the instant messaging module and the outside transmit information with each other.

10. The apparatus for sharing television signals via the instant messaging service as claimed in claim 7, wherein the instant messaging module further comprises a packet determining module for determining whether the outside network has issued the control signal via the instant messaging module.

11. The apparatus for sharing television signals via the instant messaging service as claimed in claim 10, wherein the instant messaging module further comprises an auto-reply module for determining whether to be controlled by the control signal when the packet determining module receives the control signal from the outside network.

12. The apparatus for sharing television signals via the instant messaging service as claimed in claim 7, wherein the control signal is a text message.

13. The apparatus for sharing television signals via the instant messaging service as claimed in claim 12, wherein the outside signal receiver further comprises a text parsing module for transforming the test message into the control signal.

14. A method for sharing television signals via the instant messaging service, comprising:
providing an instant messaging module used to exchange information with outside networks via the instant messaging service,
providing a television receiver used to receive the television signals having video signals and audio signals; and
connecting the television receiver with the instant messaging module, wherein the method for connecting the television receiver with the instant messaging module further comprises:
controlling the television receiver;
capturing the video signals received by the television receiver for the instant messaging module to output; and
outputting the audio signals.

15. The method for sharing television signals via the instant messaging service as claimed in claim 14, further comprising providing a television playing interface for operating the television receiver to play the television signals.

16. The method for sharing television signals via the instant messaging service as claimed in claim 15, wherein the television receiver is controlled via the television playing interface.

17. The method for sharing television signals via the instant messaging service as claimed in claim 14, wherein the audio signals are outputted via the instant messaging module.

18. The method for sharing television signals via the instant messaging service as claimed in claim 14, wherein the audio signals are outputted via an operating system.

19. The method for sharing television signals via the instant messaging service as claimed in claim 14, wherein the television receiver is under control of outside networks via the instant messaging module.

20. The method for sharing television signals via the instant messaging service as claimed in claim 14, further comprising compressing the video signals.

21. The method for sharing television signals via the instant messaging service as claimed in claim 14, further comprising buffering the video signals when the instant messaging module and the outside transferring information with each other.

22. The method for sharing television signals via the instant messaging service as claimed in claim 14, further comprising, determining whether the outside network has issued a control signal via the instant messaging module.

23. The method for sharing television signals via the instant messaging service as claimed in claim 22, further comprising, determining whether to be controlled by the control signal when receiving the control signal from the outside network.

24. The method for sharing television signals via the instant messaging service as claimed in claim 22, wherein the control signal is a text message.

25. A machine readable medium, storing a computer program for performing a method for sharing television signals via the instant messaging service, wherein the method comprises:
connecting a television receiver of the machine with an instant messaging module of the machine;
controlling the television receiver;
capturing a video signal of the television signals received by the television receiver for the instant messaging module to output; and
outputting an audio signal of the television signals received by the television receiver.

26. The machine readable medium as claimed in claim 25, further comprising enabling the machine to be controlled by outside networks via the instant messaging service.
